(19) United States
(12) Patent Application Publication
(10) Pub. No.: US 2012/0286047 A1
(43) Pub. Date: Nov. 15, 2012

(54) CODE READING APPARATUS AND METHOD

(75) Inventor: Hidehiro Naito, Shizuoka-ken (JP)

(73) Assignee: TOSHIBA TEC KABUSHIKI KAISHA, Tokyo (JP)

(21) Appl. No.: 13/448,556

(22) Filed: Apr. 17, 2012

(30) Foreign Application Priority Data
May 13, 2011 (JP) 2011-108648
Feb. 23, 2012 (JP) 2012-037866

(51) Int. Cl. G06K 7/10

(52) U.S. Cl. 235/455

(57) ABSTRACT

According to one embodiment, a code reading apparatus comprises an image pickup unit, a light source, a reading unit and a light source control unit. The image pickup unit configured to image pickup a commodity placed in a image pickup area. The light source configured to irradiate pulsed light towards the image pickup area. The reading unit configured to read the information related to the commodity from the image picked-up by the image pickup unit. The light source control unit configured to increase the pulse width of the pulsed light gradually until the quantity of light reaches a level at which the reading unit can read the information when the light source is turned on, and decrease the pulse width of the pulsed light gradually until the quantity of light becomes 0 when the light source is extinguished.

### CROSS-REFERENCE TO RELATED APPLICATION

The present application contains subject matter related to that disclosed in Japanese Priority Patent Application No. 2011-108648 filed in the Japan Patent Office on May 13, 2011 and Japanese Priority Patent Application No. 2012-037866 filed in the Japan Patent Office on Feb. 23, 2012 the entire contents of which are hereby incorporated by reference.

### FIELD

Embodiments described herein relate to a code reading apparatus and method.

### BACKGROUND

At present, a code symbol reading apparatus is used in a supermarket or other shops which image pickups the image of a code symbol using the area image sensor of a CCD (Charge Coupled Device Image Sensor) image pickup element and outputs a commodity code to a POS (Point Of Sales) terminal. A light source such as an LED (Light Emitting Diode) is used in this code symbol reading apparatus which gives off pulsed light to illuminate a commodity or code symbol to guarantee the brightness needed for a image pickup. Moreover, the image pickup of a image pickup element is synchronous with the timing of the pulsed light.

### BRIEF DESCRIPTION OF THE DRAWINGS

FIG. 1 is an external perspective view roughly showing the elements of a checkout lane system provided with a code reading apparatus according to an embodiment;

FIG. 2 is an external perspective view roughly showing the elements of the code reading apparatus;

FIG. 3 is a block diagram of the code reading apparatus;

FIG. 4 is a timing chart showing the output timing of an image pickup signal and a light control signal during an illumination starting control;

FIG. 5 is a timing chart showing the output timing of the image pickup signal and a light control signal during an extinguishment control;

FIG. 6 is a flow chart showing the process of an illumination starting processing and an extinguishment processing carried out by the code reading apparatus.

### DETAILED DESCRIPTION

According to one embodiment, a code reading apparatus comprises an image pickup unit, a light source, a reading unit and a light source control unit. The image pickup unit configured to image pickup a commodity placed in a image pickup area. The light source configured to irradiate pulsed light towards the image pickup area. The reading unit configured to read the information related to the commodity from the image picked-up by the image pickup unit. The light source control unit configured to increase the pulse width of the pulsed light gradually until the quantity of light reaches a level at which the reading unit can read the information when the light source is turned on, and decrease the pulse width of the pulsed light gradually until the quantity of light becomes 0 when the light source is extinguished.

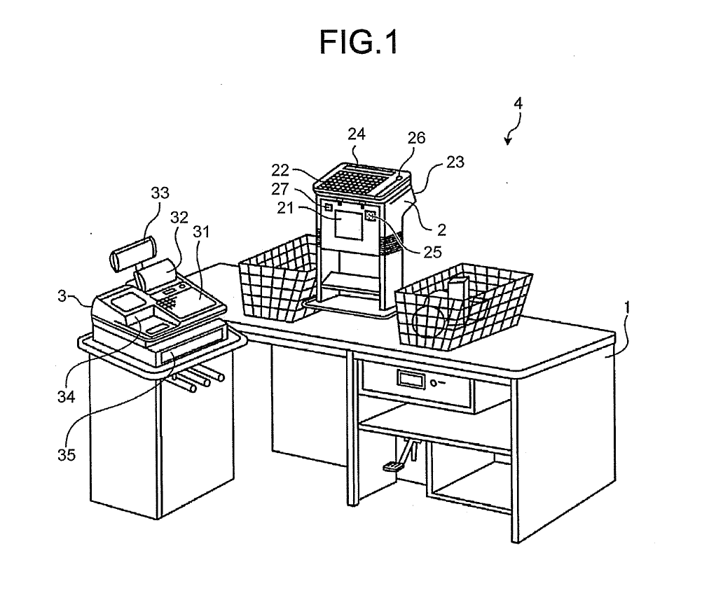

FIG. 1 is an external perspective view roughly showing the elements of a checkout lane system provided with the code reading apparatus described in this embodiment. As shown in FIG. 1, the checkout lane system 4 comprises: a bagging platform 1 configured to hold a commodity-containing shopping basket; a code reading apparatus 2 vertically configured at the substantially center position of the bagging platform 1; and a POS terminal 3 that is connected with the code reading apparatus 2 by a transmission path (not shown) in a mutually communicable manner.

The POS terminal 3 registers the sales of the commodities purchased by a customer. As shown in FIG. 1, a keyboard 31, an operator-oriented display 32, a customer-oriented display 33, a printer 34 for printing receipts and the like and a cash drawer 35 for accommodating cash are configured in the POS terminal 3. A current receipt/disbursement key necessary for the account settlement of commodities is configured on the keyboard 31. The POS terminal 3 has the same structure and functions with the standard POS terminal used in such a checkout lane system.

The code reading apparatus 2 is an apparatus configured to read the barcode adhered on a commodity and output the commodity information contained in the read barcode to the POS terminal 3. As shown in FIG. 1, the code reading apparatus 2 comprises a reading window 21, a keyboard 22, a customer-oriented display 23, a shop assistant-oriented display 24, a buzzer 25, an LED 26 and a power switch 27.

In the case where a commodity cannot be registered using a barcode, the input of various keys is accepted by the keyboard 22. The customer-oriented display 23 is configured to display the name and the price of a registered commodity for a customer or shop assistant. The shop assistant-oriented display 24 is configured to display the name and the price of a registered commodity as well as other error information for an operating shop assistant.

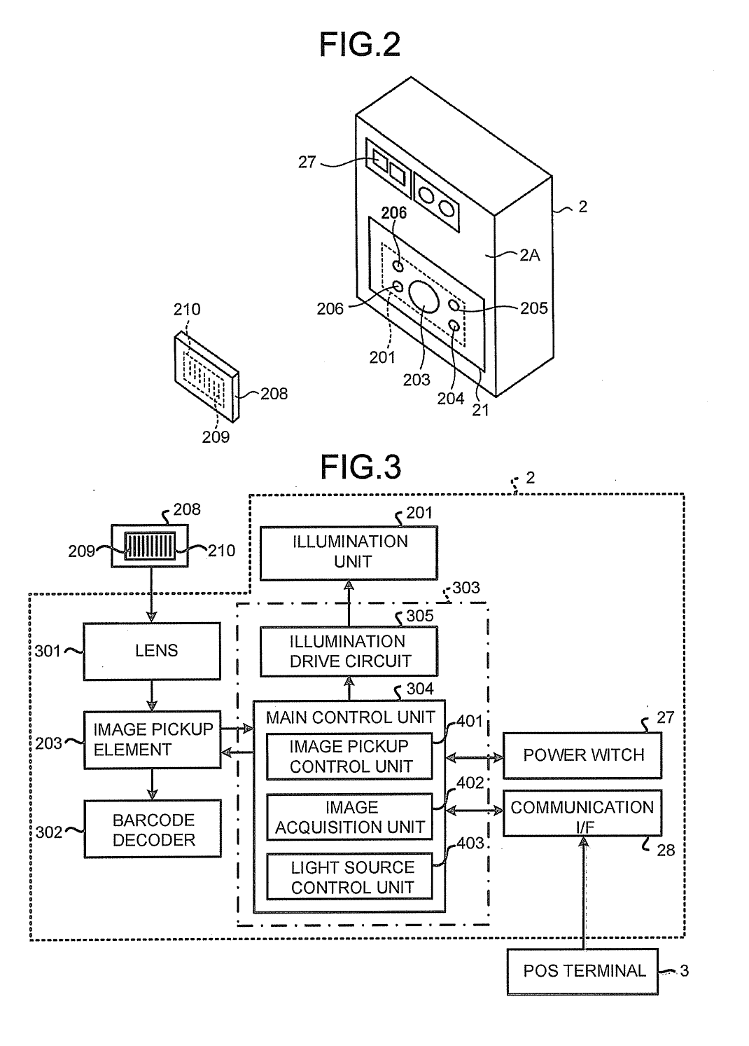

A image pickup element 203 (refer to FIG. 2) is configured within the code reading apparatus 2 provided with the reading window 21. The image pickup element 203, which may be, for example, a image pickup device using a CCD (Charge Coupled Device) or CMOS (Complementary Metal Oxide Semiconductor) or the like, image pickups the image of a code symbol (barcode or two-dimensional code) or liquid crystal screen placed in a image pickup area opposite to the reading window 21.

The power switch 27 is a switch that switches on/off the power supply of the code reading apparatus 2.

FIG. 2 is an external perspective view roughly showing the elements of the code reading apparatus. As shown in FIG. 2, the code reading apparatus 2 has a image pickup element 203, an illumination unit 201 and the power switch 27 on the front surface 2a of the main body thereof. The operator manually places a commodity 208 opposite to the side of the front surface 2a of the code reading apparatus 2. A piece of paper 210, on which a barcode 209 is printed, is adhered on the commodity 208. When reading the barcode 209 with the cod reading apparatus 2, the operator manually adjusts the barcode 209 printed on the paper 210 adhered on the commodity 208 into the image pickup area of the image pickup element 203. Moreover, although this embodiment is described based on an example in which the object read by the code reading apparatus 2 is the barcode 209, the present invention is not limited to this, any code symbol such as a two-dimensional code can be the read object.

The image pickup element 203 pickup image which is located on the front surface 2a of the code reading apparatus 2 and contains the barcode 209, that is receives reflected light from the barcode 209 and the commodity 208 that the paper 210 printed with the barcode 208 is adhered, thereby converting the light reflected from the commodity 208 to an electric information to output the image information of the commodity 208.

The illumination unit 201 is a light source which irradiates lights towards the image pickup area of the image pickup unit 203. In this embodiment, the illumination unit 201 is formed by arranging four LEDs 204-207 around the image pickup element 203. In this embodiment, the light irradiation range of the illumination unit 201 is substantially as large as or larger than the image pickup area of the image pickup element 203.

FIG. 3 is a block diagram of the code reading apparatus 2. A lens 301 is configured within the reading window (refer to FIG. 2) to gather the light in the image pickup area to form an image on the image pickup element 203. The image pickup element 23 converts an optical signal transmitted to the image pickup element 23 to an electric signal according to a image pickup signal input by the image pickup control unit 401 and outputs the electric signal to a barcode decoder 302 as image information.

The barcode decoder 302 extracts the image of the barcode 209 contained in the image information input by the image pickup element 203, and reads commodity-related information from the extracted image of the barcode 209.

A control unit 303, which controls the image pickup of the image pickup element 203 and the light irradiation of the illumination unit 201, comprises a main control unit 304 and an illumination drive circuit 305. The main control unit 304 comprises a CPU (Central Processing Unit), an RAM (Random Access Memory), an ROM (Read Only Memory) and an I/O port. Moreover, the main control unit 304 is connected with the image pickup element 203 and the illumination drive circuit 305 to control the image pickup element 203 and the illumination drive circuit 305.

The main control unit 304 is further connected with the power switch 27. When powered on by switching on the power switch 27, the main control unit starts the code reading apparatus 2. Further, when the power switch 27 is switched off, the main control unit 304 ends the processing of the code reading apparatus and cuts off the power supply.

Further, the main control unit 304 enters into a power-saving mode automatically if a given time elapses from the moment the barcode decoder 302 reads no code symbol. Moreover, the main control unit 304 is further connected with a communication I/F 28. When accepting an input from the POS terminal 3 or the keyboard 22 through the communication I/F 28, the main control unit 304 returns to the normal mode from the power-saving mode.

The CPU of the main control unit 304 acts according to a program stored in the ROM developed on the RAM, thereby functioning as the image pickup control unit 401, an image acquisition unit 402 and a light source control unit 403, as shown in FIG. 3.

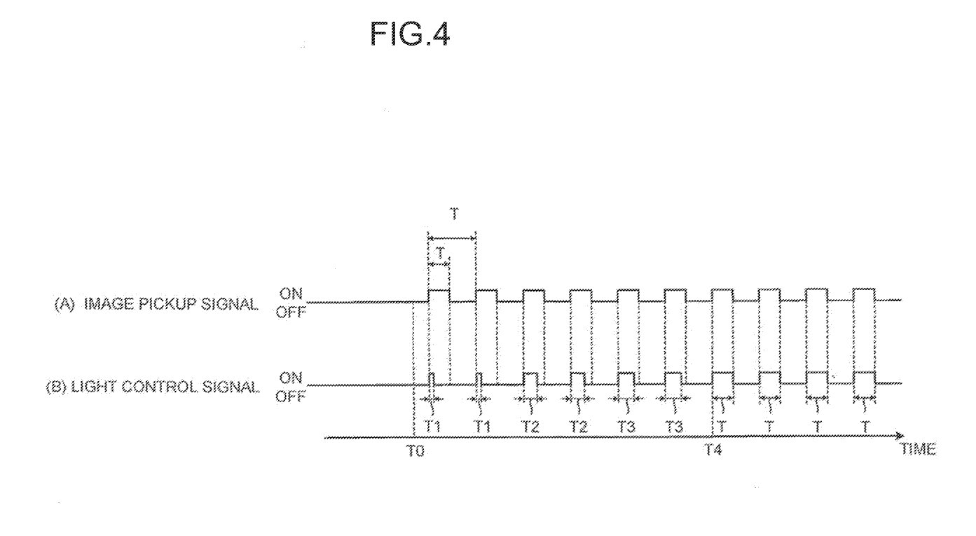

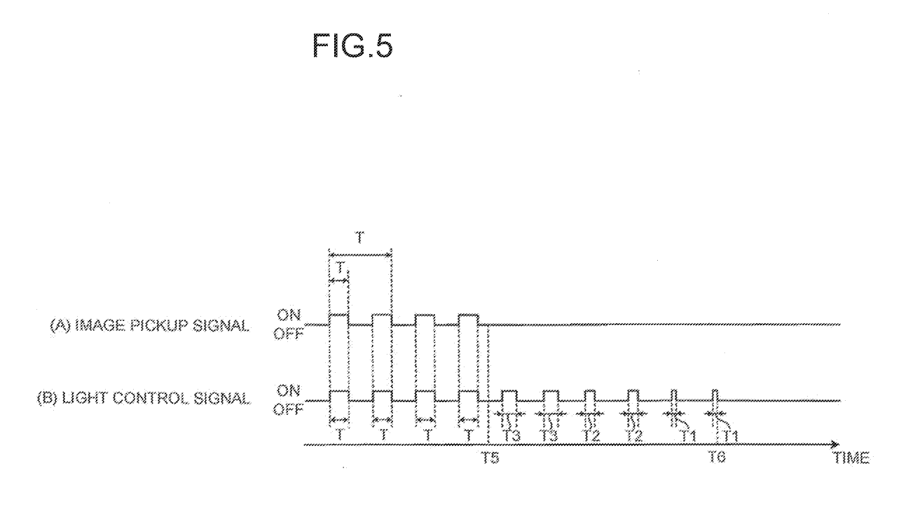

The image pickup control unit 401 outputs a image pickup signal (refer to FIG. 4 and FIG. 5) indicating an image pickup to the image pickup element 203 to control the image pickup of the image pickup element 203.

The image pickup element 203 image pickups the image of a image pickup area when the image pickup signal is ON, and takes no image pickup when the image pickup signal is OFF.

The image acquisition unit 402 acquires the image picked-up by the image pickup element 203 and outputs the image to the RAM of the main control unit 304.

The light source control unit 403 outputs a light control signal (refer to FIG. 4 and FIG. 5) indicating a light irradiation to the illumination drive circuit 305 to control the light irradiation of the illumination unit 201 through the illumination drive circuit 305.

The light control signal is, for example, a rectangular pulse signal, the illumination drive circuit 305 enables/disenables the LEDs 204-207 to give off light according to the ON/OFF state of the pulse signal. That is, the illumination drive circuit 305 enables the LEDs 204-207 to give off light when the light control signal is ON, and disenables the LEDs 204-207 to give off light when the light control signal is OFF.

The light source control unit 403 controls the illumination starting of the illumination unit 201 when the power switch 27 is switched on. Moreover, the light source control unit 403 may control the illumination starting of the illumination unit 201 after receiving a switch-on signal indicating the switch-on of the illumination unit 201 from the POS terminal 3.

Moreover, the light source control unit 403 controls the extinguishment of the illumination unit 201 when the power switch 27 is switched off. Moreover, the light source control unit 403 may control the extinguishment of the illumination unit 201 after receiving a switch-off signal indicating the switch-off of the illumination unit 201 from the POS terminal 3.

Moreover, the light source control unit 403 controls the extinguishment of the illumination unit 201 after entering into a power-saving mode and the illumination starting of the illumination unit 201 after returning to the normal mode from the power-saving mode.

When controlling the illumination starting or extinguishment of the illumination unit 201, the light source control unit 403 changes the quantity of light gradually until the quantity of light of the illumination unit 201 reaches a given level. When controlling the illumination starting or extinguishment of the illumination unit 201, the light source control unit 403 changes the pulse width of pulsed light gradually until the quantity of light of the illumination unit 201 reaches a given level. Moreover, the light source control unit 403 may gradually change the quantity of light of the illumination unit 201 in other ways.

Next, the illumination starting control carried out by the light source control unit 403 is described in more detail with reference to FIG. 4.

FIG. 4 is a timing chart showing the output timing of a image pickup signal and a light control signal during an illumination starting control. The switch-on of the power switch 27 at t0 is shown in FIG. 4.

FIG. 4 (a) shows an output timing of a image pickup signal during an illumination starting control. The image pickup control unit 401 starts to output a image pickup signal if the power switch 27 is switched on at t0. The image pickup control unit 401 outputs a rectangular pulse signal having a given pulse width t, a given pulse period T and a given pulse interval (T-t) to the image pickup element 203 as a image pickup signal, as shown in FIG. 4(a). The image pickup element 203 image pickups a picked-up area only at the pulse width t in each pulse period T.

FIG. 4 (a) shows an output timing of a light control signal during an illumination starting control. The light control signal output processing carried out during the period from t0-t4 is called an illumination starting processing.

When the power switch 27 is switched on at t0, the light source control unit 403 gradually increases the pulse width of the light control signal to pulse widths t1, t2 and t3 (t1<t2<t3), as shown in FIG. 4(b). Moreover, the light source control unit 403 outputs the light control signal having the same pulse width t with the image pickup signal to the illumination drive circuit 305 after t4.

As stated above, the illumination unit 201 gives off light when the light control signal is ON, therefore, the pulse width of the pulsed light given off by the illumination unit 201 gradually increases to the pulse widths t1, t2 and t3 as well, and after t4, the illumination unit 201 gives off pulsed light having the same pulse width t with the image pickup signal. That is, the light source control unit 403 gradually increases the quantity of light of the illumination unit 201 in the period from t0-t4 when an illumination is started until the quantity of light of the illumination unit 201 reaches a given level.

The given quantity of light refers here to the quantity of light that is gained by the pulsed light having a pulse width t and a pulse period T in a given time and is bright enough for the barcode decoder 302 to read commodity information from the image of the barcode 209.

Moreover, the code reading apparatus can further read other information except for the barcode 209 from the commodity image by setting the quantity of light for reading the other information to a given one and adjusting the pulse width t and the pulse period T.

In this way, by increasing the quantity of light of the illumination 201 gradually when the illumination unit 201 is turned on, the eyes of the operator are protected against dazzling light.

Moreover, the light source control unit 403 outputs light control signals having the same pulse width (t1, t2 and t3) for many times (2 times herein) during an illumination starting control, thereby periodically increasing the pulse width of the pulsed light given off by the illumination unit 201 to pulse widths t1, t2 and t3.

Further, the light source control unit 403 may increase the pulse width by given times, for example, by two times, during the illumination starting control.

Further, the light source control unit 403 outputs the light control signal and the image pickup signal synchronously. That is, as shown in FIG. 4, the pulse period of the light control signal is set to be as long as the pulse period T of the image pickup signal to be output in accordance with the timing of the image pickup signal. Therefore, the illumination unit 201 gives off pulsed light synchronous with the image pickup signal. As the illumination unit 201 gives off light in accordance with the timing of the image pickup signal, the picked-up area or the commodity 208 placed in the picked-up area can be effectively illuminated to enable the image acquisition unit 402 to acquire an image of a higher quality.

Moreover, the light source control unit 403 keeps the pulse period T of the light control signal unchanged during the illumination starting control. That is, light flickers when the pulse period of the pulsed light changes. Thus, even the pulse width (t1, t2, t3) of the pulsed light is changed gradually, the light flickering of the illumination 201 is prevented in this embodiment as the pulse period T of the pulsed light is fixed.

Moreover, in FIG. 4, the light source control unit 403 sets the pulse widths t of the light control signal and the image pickup signal to be the same during the period from the moment the illumination starting processing is ended to the moment an extinguishment processing is started (that is, the period between t4 and t5), however, the pulse widths may be different from each other as long as the two signals are synchronously kept in an ON state.

Next, the extinguishment control carried out by the light source control unit 403 is described in detail with reference to FIG. 5.

FIG. 5 is a timing chart showing the output timing of a image pickup signal and a light control signal during an extinguishment control. The switch-off of the power switch 27 at t5 is shown in FIG. 5.

FIG. 5 (a) shows an output timing of a image pickup signal during an extinguishment control. The image pickup control unit 401 stops outputting a image pickup signal if the power switch 27 is switched off at t5.

FIG. 5 (b) shows an output timing of a light control signal during an extinguishment control. In FIG. 5, the light control signal output processing carried out during the period from t5 to t6 is called an extinguishment processing.

If the power switch 27 is switched off at t5, then the light source control unit 403 gradually decreases the pulse width t of a light control signal from t3 to t1 (t3>t2>t1) and stops outputting the light control signal after t6. Therefore, the pulse width of the pulsed light given off by the illumination unit 201 is also decreased gradually until the illumination unit 201 is extinguished.

That is, the light source control unit 403 gradually decreases the quantity of light of the illumination unit 201 in the period from t5 to t6 during an extinguishment processing until the quantity of light of the illumination unit 201 reaches a given level (0). Therefore, it may prevent that the illumination of the illumination unit 201 suddenly become dark, the eyes of the operator cannot keep up with sudden change of lightness, so the illumination may easy on operator's eyes when the light is extinguished.

Moreover, the light source control unit 403 outputs light control signals having the same pulse width (t1, t2, t3) for many times (2 times herein) during an extinguishment control, thereby decreasing the pulse width of the pulsed light given off by the illumination unit 201 periodically from t3 to t1 (t3>t2>t1).

Further, the light source control unit 403 may decrease the pulse width by given times, for example, by two times, during the extinguishment control.

Moreover, although in this case the light source control unit 403 decreases the pulse width of the light control signal gradually in an order of t, t3, t2 to t1, the pulse period T is remained unchanged. Thus, like in the illumination starting control, the light flickering of the illumination unit 201 is prevented to carry out an illumination control harmless to the eyes of the operator.

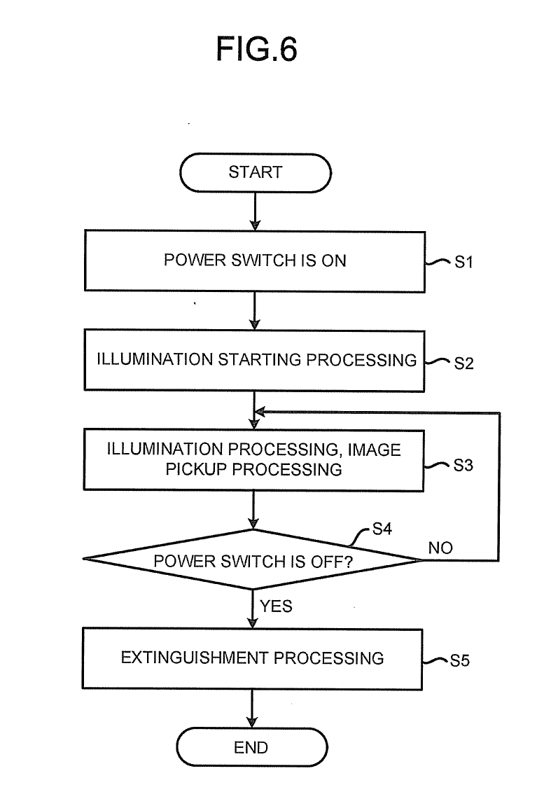

Next, the process of an illumination starting processing and an extinguishment processing is described below. FIG. 6 is a flow chart showing the process of an illumination starting processing and an extinguishment processing carried out by the code reading apparatus 2.

If the power switch 27 of the code reading apparatus 2 is switched on (Act S1), then the main control unit 304 starts all the elements thereof, and the light source control unit 403 controls the illumination starting of the illumination unit 201 (Act S2). That is, the light source control unit 403 gradually increases the pulse width of a light control signal in an order of t1, t2, t3 (t1<t2<t3) and outputs the pulse width to the illumination drive circuit 305. The illumination unit 201 gradually increases the pulse width of pulsed light in an order of t1, t2, t3 under the control of the illumination drive circuit 305 to make LEDs 204-207 give off light. Moreover, the image pickup control unit 401 outputs a image pickup signal to enable the image pickup element 203 to carry out a image pickup processing (Act S2).

After the illumination starting processing is ended, the light source control unit 403 outputs the light control signal and the image pickup signal synchronously to enable the LEDs 204-207 to continue to give off pulsed light (Act S3). Moreover, the image pickup control unit 401 continues to output a image pickup signal to image pickup the commodity or code symbol placed in a picked-up area (Act S3).

Then, the main control unit 304 determines whether or not the power switch 27 is switched off (Act S4). The flow returns to Act S3 if the power switch 27 is still switched on (Act S4: No). The light source control unit 403 extinguishes the illumination unit 201 (Act S5) if the power switch 27 is switched off (Act S4: Yes). That is, the light source control unit 403 gradually decreases the pulse width of the light control signal in an order of t3, t2, t1 (t3>t2>t1) and outputs the pulse width to the illumination drive circuit 305. The illumination unit 201 gradually decreases the pulse width of the pulsed light in an order of t3, t2, t1 under the control of the illumination drive circuit 305 to make LEDs 204-207 give off light first and give off no light then. Further, the image pickup control unit 401 stops outputting the image pickup signal. Moreover, the main control unit 304 gets itself stopped (Act S5).

Besides, in the description above, the pulse width is periodically changed to pulse widths t1, t2 and t3, however, the pulse width may also be periodically changed to other more pulse widths.

Although the present invention has been discussed with respect to an embodiment thereof, this embodiment is merely illustrative but not restrictive of the present invention. The novel embodiment described herein may also be embodied in a variety of other forms, furthermore, various omissions, substitutions and modifications can be devised without departing from the scope of the present invention. The accompanying claims and their equivalents are intended to cover such forms and modifications as would fall within the scope and spirit of the invention.

For instance, in the description above, the light source control unit 403 changes the quantity of light of the illumination unit 201 by changing the pulse width of the pulsed light, however, the approach for changing the quantity of light is not limited to this. For instance, the light source control unit 403 may change the quantity of light of the illumination unit 201 by changing the current flowing in a light-emitting element (for example, the currents flowing in LEDs 204-207). Moreover, when there are a plurality of light-emitting elements (for example, LEDs 204-208, as shown in FIG. 2) in the illumination unit 201, the light source control unit 403 may change the quantity of light of the illumination unit 201 by increasing or decreasing the light-emitting elements (LEDs) that are turned on/extinguished.

Moreover, there are a code reading apparatus 2 and a POS terminal 3 in the description above, however, the present invention is not limited to this, the code reading apparatus 2 and the POS terminal 3 may be integrated in the same apparatus. As an example, the reading apparatus 2 and the POS terminal 3 may be applied in an automatic POS device for the customer to carry out a commodity settlement automatically.

Further, the program executed by the code reading apparatus 2 in this embodiment is pre-compiled in an ROM. However, the present invention is not limited to this, for instance, the program executed by the code reading apparatus 2 in this embodiment may be stored in a computer-readable memory medium such as CD-ROM, FD (floppy drive), CD-R, DVD (digital versatile disk) as an installable or executable file, or stored in a computer connected with a network such as the Internet to be provided through a network download, or provided or published by a network such as the Internet.

In this embodiment, the program executed by the code reading apparatus 2 consists of modules including each of the foregoing units (the main control unit 304, the image pickup control unit 401, the image acquisition unit 402 and the light source control unit 403), however, as an actual piece of hardware, a CPU reads a program from the ROM and then executes the program to load each of the foregoing units to a main memory to generate the main control unit 304, the image pickup control unit 401, the image acquisition unit 402 and the light source control unit 403 on the main memory.

Moreover, the functions achieved by the units (e.g. the image pickup control unit 401, the image acquisition unit 402 and the light source control unit 403) of the code reading apparatus 2 can be partially set in the POS terminal 3, and the light control on the code reading apparatus may be carried out by the POS terminal 3 through a bus line or interface.

As stated above, in accordance with this embodiment, the quantity of light of the illumination unit 201 is gradually changed when a light source is turned on or turned off, thus, the illumination may easy on operator's eyes.

Moreover, in accordance with this embodiment, a light source is turned on or extinguished by changing the pulse width of pulsed light gradually, thus, the quantity of light of the light source can be changed gradually to turn on or extinguish the light source, the illumination may easy on operator's eyes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A code reading apparatus, comprising:
an image pickup unit configured to image pickup a commodity placed in a image pickup area;
a light source configured to irradiate pulsed light towards the image pickup area;
a reading unit configured to read the information related to the commodity from the image picked-up by the image pickup unit; and
a light source control unit configured to increase the pulse width of the pulsed light gradually until the quantity of light reaches a level at which the reading unit can read the information when the light source is turned on, and decrease the pulse width of the pulsed light gradually until the quantity of light becomes 0 when the light source is extinguished.

2. The code reading apparatus according to claim 1, wherein
the light source control unit keeps the pulse period of the pulsed light unchanged when increasing or decreasing the pulse width of the pulsed light gradually.

3. The code reading apparatus according to claim 1, wherein
the light source control unit changes the pulse width periodically by multiple successive pulsed lights having the same pulse width when increasing or decreasing the pulse width of the pulsed light gradually.

4. The code reading apparatus according to claim 1, wherein the light source control unit controls the light source under the light is turned on when the code reading apparatus is turned on and the light source under the light is extinguished when the code reading apparatus is powered off.

5. The code reading apparatus according to claim 1, wherein
the light source control unit controls the light source under the light is extinguished when the code reading apparatus is power-saving mode and the light source under the light is turned on when the code reading apparatus is returned from power-saving mode.

6. A method, comprising:
imaging pickup a commodity placed in a image pickup area;
irradiating pulsed light towards the image pickup area;
reading the information related to the commodity from the image picked-up by the image pickup unit;
increasing the pulse width of the pulsed light gradually until the quantity of light reaches a level at which the reading unit can read the information when the light source is turned on; and
decreasing the pulse width of the pulsed light gradually until the quantity of light becomes 0 when the light source is extinguished.
